(19) United States
(12) Patent Application Publication
(10) Pub. No.: US 2015/0193387 A1
(43) Pub. Date: Jul. 9, 2015

(54) CLOUD-BASED FONT SERVICE SYSTEM

(71) Applicant: Academia Sinica, Taipei (TW)

(72) Inventors: Jan-Ming HO, Taipei (TW); Jeng-Wei LIN, Taichung (TW); Ray-I CHANG, Taipei (TW); Shu-Yu LIN, Chiayi County (TW); Chih-Yin WANG, Taipei (TW); You-Jyun WANG, New Taipei (TW)

(21) Appl. No.: 14/549,983

(22) Filed: Nov. 21, 2014

(30) Foreign Application Priority Data
Jan. 6, 2014 (TW) 103100398

(51) Int. Cl. G06F 17/21

(52) U.S. Cl. CPC G06F 17/214

(57) ABSTRACT

Disclosed is a cloud-based font service system to be installed in a cloud server, comprising: a glyph construction module to allow users to construct a plurality of glyph patterns in order to form a computer font; a font management module allowing users to add, modify or delete glyph patterns of computer fonts and including a font shelving tool to allow an administrator of a computer font to determine trading conditions; and a font application module to display particular glyphs of the computer font for trading. The invention allows users to select glyphs from existing computer fonts and modify them to form new computer fonts for trading.

### TECHNICAL FIELD OF THE INVENTION

The present invention relates to a cloud-based font service system, especially to a font service system that provides users useful tools for the creation and the commercialization of computer fonts.

### BACKGROUND OF THE INVENTION

As the Internet becomes an important part of everybody's life, all kinds of information are expressed in digitalized forms, so that they may be distributed in the network systems. Clear and good-looking expressions of information play an important role in the distribution of information.

All types of written information displayed in electronic platforms, such as in a computer display device, are expressed by computer fonts with various typefaces in combination. Different combinations of typefaces give the information so expressed different style and character, which in turn influence readers' feeling and appreciation to the contents of the information, and also to the webpage, website and publication that include the information. The computer font is an important element in the design of webpages and publications. While most people know how to make good use of the variety of typefaces, very few people know how to construct a computer font. Although many computer fonts are available in the market, suppliers of the computer fonts are limited to those who have sufficient technology and resources to create computer fonts. Users can only select desirable computer fonts in the marketplace, install and use them in the documents they create.

Despite the fact that many computer users would wish to create computer fonts that represent their own writing styles, there are no useful tools or computer software that provides user-friendly user interfaces. Some cloud-based computer font service systems, such as the JustFont® system, allow users to construct their own computer fonts but users are only allowed to use glyphs provided by the service providers as elements of the computer fonts that they construct. No cloud-based computer font service system allows users to construct computer fonts using the glyphs they design.

In addition, in most information exchange platforms, graphic expressions of information provided by the platform are displayed in a user computer using special computer fonts provided by/downloaded from the platform. If a user did not download the necessary computer fonts into user's computer, the information will either be displayed using the default compute fonts of the computer or will not be displayed. As a result, the information cannot be displayed correctly, or simply cannot be displayed. In order to avoid such consequences, many information exchange platforms would embed or incorporate the required computer fonts in the information provided, so that computer fonts are provided to the users along with the corresponding contents. However, such approach is not practicable when the computer fonts are of the Southeastern Asian languages; a glyph set that represents a Southeastern Asian language, such as the Chinese language, would include a large volume of glyphs with complicated structures. To incorporate such a computer font in a file including information to be displayed needs relatively large capacity of transmission and memory, therefore is not useful in network transmission of information or cloud-based utilization of information.

It is thus necessary to provide a cloud-based service system for computer fonts that allows users to easily create their own computer fonts and to commercialize the computer fonts so created.

It is also necessary to provide a convenient cloud-based computer font service system, whereby information expressed in particular computer fonts may be displayed correctly without the need of downloading computer font files.

### OBJECTIVES OF THE INVENTION

One objective of this invention is to provide a cloud-based font service system that allows users to create computer fonts without the need of the users to have knowledge in the computer font related technology.

Another objective of this invention is to provide a cloud-based font service system that allows users to commercialize through the Internet computer fonts they created.

Another objective of this invention is to provide a cloud-based font service system that allows display of information with particular computer fonts, without the need of downloading glyph sets of the computer fonts.

### SUMMARY OF THE INVENTION

According to the cloud-based font service system of this invention, convenient glyph design tools are provided, to allow users to create their own computer fonts easily and quickly. The computer fonts so created may be traded in the cloud-based system. In the construction of computer fonts, the present invention provides a plurality of inputting tools, so that users may input graphic materials of the glyphs via a plurality of channels, such as by hand-writing, in a printed picture or in a digital image. The graphic materials so input are later recognized and vectorized, to serve as materials of glyphs in the creation of computer fonts. In the management of computer fonts, the present invention provides useful tools for addition, modification and deletion of glyphs and their materials stored in the invented system. The present invention also provides tools for users to define a group of glyphs to be a “glyph set” or “font file.” The invention further provides useful tools for users to share and trade computer fonts they created. In the generation of glyph sets, the present invention extracts glyphs from images input by user and link them to glyph codes of a particular font file, whereby memory capacity needed for font files are dramatically reduced. The font files so generated are stored in a cloud server, allowing users to download and to use glyphs of the font files in a document to be displayed in a network platform.

The cloud-based font service system of this invention may be installed in a cloud server and includes a glyph construction module, a font management module and a font application module. The glyph construction module provides a glyph construction tool and a glyph input interface, to allow users to input graphic materials to construct glyph patterns corresponding to a plurality of symbols, words or characters. The glyph patterns are converted to digitized glyphs in particular formats, to collectively form a glyph set or font file. The glyph construction module also provides a font storage device, to store font files constructed by users, as well as corresponding management information, in the cloud server. In certain preferred embodiments, the glyph input interface accepts glyph inputs in forms of handwriting, printed or digital pictures, written documents or digital glyphs.

The font management module of this invention provides a glyph edition tool that allows users to add, modify or delete glyph patterns stored in the cloud server and a font shelving interface that allows administrator of a computer font to determine access rights of the computer font, so that the computer font may be share, exchanged or traded. In addition, the font application module provides a computer font trading interface that displays particular glyphs of a computer font stored in the cloud server in a particular format, so that consumers may select, download or use the computer fonts in consumers' computer or in an Internet webpage.

These and other objectives and advantages of this invention will be clearly appreciated from the detailed description by referring to the following drawings.

### BRIEF DESCRIPTION OF THE DRAWINGS

FIG. 1 is systematic diagram of one embodiment of the cloud-based font service system of this invention.

FIG. 2 is systematic diagram of the glyph construction module of the invented cloud-based font service system.

FIG. 3 shows an example of the glyph input interface of this invention.

FIG. 4 is systematic diagram of the font management module of this invention.

FIG. 5 is the flowchart of a method for process of modification of a glyph, according to one example of this invention.

FIG. 6 is systematic diagram of one embodiment of the font application module 30 of the cloud-based font service system 100 of this invention.

### DETAILED DESCRIPTION OF THE INVENTION

Several embodiments of the cloud-based font service system will be described in the followings. It shall be noted that the embodiments are given for purpose of illustrating the structure and applications of this invention, without limiting the present invention to particular examples or their combinations. For those having ordinary skills in the art, it is easy for them to modify or derive the embodiments to realize systems and methods with the same or similar effects. These modifications and derivations shall belong to the scope of this invention, as defined in the attached claims.

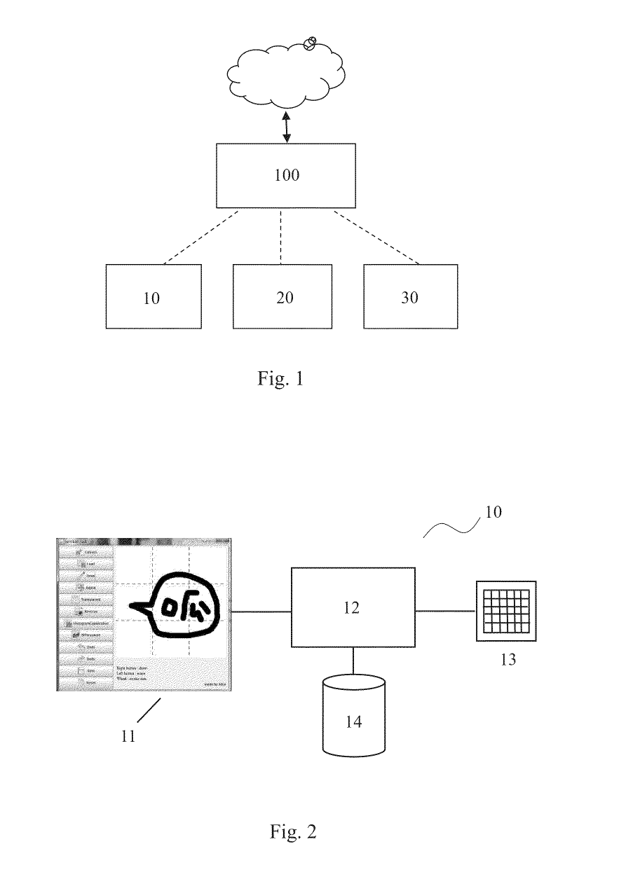

FIG. 1 is systematic diagram of one embodiment of the cloud-based font service system of this invention. As shown in this figure, the invented cloud-based font service system 100 includes a glyph construction module 10, a font management module 20 and a font application module 30. The invented system 100 may be installed to a server computer generally referred to as cloud server, which allows a substantial amount of users to access via the Internet or other network systems, to exchange information with the system 100. Server computers, their applicable software and hardware and network systems are known to those having ordinary skills in the art. Detailed description thereof is thus omitted.

“Glyph” is the basic unit of a computer font in the cloud-based font service system of this invention. A computer font or a font system may be defined as a set of glyphs that represent respective symbols, letters, characters and/or words in a number sufficient to construct a document and in a format to be processed by a computer device. A glyph, as unit of a computer font, includes two parts: the glyph pattern and its corresponding glyph code in the computer font. The glyph pattern is the image or shape of the glyph, i.e., the abstractive concept describing the design of a symbol, a letter, a character or a word, such as a figure, a written description or a programmatic description. The glyph code denotes to the representative code of the glyph in a particular computer font system that allows the computer system to allocate the glyph among all glyphs in the computer font. In addition to them, information relating to a glyph may further include start position of each element of the glyph when displayed.

In a conventional computer font system, a font file shall include all usable symbols, letters, characters and/or words in a language system. According to this invention, however, a computer font or a font file includes the glyph pattern and the glyph code of glyphs that are adopted by the creator, designer or administrator of the particular computer font. Although it is not intended to limit the scope of this invention, the inventors have found that most users would use only a small portion of the symbols, letters, characters or words defined in a standard computer font in the documents they prepare. Taking the Chinese character system as an example, a standard computer font that includes the “frequently used” Chinese characters may include glyphs representing more than 10,000 Chinese characters. A more complete computer font would include over 10 thousand Chinese characters. The de facto standard Chinese character glyph set in Taiwan, the Big-5 Code system, includes about 13,051 Chinese characters. However, only about 1,000-3,000 Chinese characters would be sufficient for most people to use in the preparation of documents. In particular, a computer font including glyphs representing several dozens to several hundreds of Chinese characters created by a user using this invention would satisfy the needs of the user, since the computer font is constructed by the user to include glyphs adopted by the user for further use of the user. Under such design of this invention, memory capacity needed for the computer fonts is largely reduced. The computer fonts so constructed are easy to store, manage and transmit. In case glyphs included in one computer font are not enough, the user may use the glyph construction module to add needed glyphs at any time.

FIG. 2 is systematic diagram of the glyph construction module 10 of the invented cloud-based font service system 100. The glyph construction module 10 allows users to construct computer fonts online, after having logged in the system, and, as shown in the figure, includes a glyph input interface 11 and a glyph construction tool 12. The glyph input interface 11 provides a human-machine interface accessible from remote, to allow users to construct computer fonts from remote. The glyph input interface 11 further allows users to input graphic materials to be used in the creation of glyphs and allows creators of particular computer fonts to view glyph patterns and other information relating to the computer fonts. The glyph construction tool 12 serves to use the operational capacity of the cloud-based font service system 10 in converting the graphic materials input from the glyph input interface 11 into digitized glyph elements.

FIG. 3 shows an example of the glyph input interface 11 of this invention. As shown in this figure, a window 111 is provided in the glyph input interface 11, to display glyph patterns or their fragments that a user has input or glyph patterns or fragments under construction or modification. The glyph input interface 11 provides a plurality of input channels for the users to input graphic materials for glyphs (glyph material), including, for example, handwriting input actuated by “Draw” key 112, downloading actuated by “Load” key 113 etc. The glyph input interface 11 further provides a glyph material modification tools, represented by “Adjust” key 114 for tilt adjustment, key for adjustment of stroke thickness (not shown) etc. and glyph material pre-processing keys, such as “BitThreshold” key 115 to adjust threshold values for conversion of colored images into gray-leveled images. In addition, the glyph input interface 11 also provides an “Extract” key 116 to actuate vectorization of strokes of a glyph, so to allow users to convert images of the glyph materials into vectorized patterns.

When constructing a glyph, a user connects a graphic input device 13, 13 to the glyph construction tool 12 and inputs graphic materials for the glyph in the glyph input interface 11. The graphic input device 13, 13 may be any input device that allows the user to input graphic materials. Examples of the graphic input device 13, 13 include touch screen of a flat computer or mobile handset, a computer mouse or a hand-writing panel. When the input graphic materials of the glyph are detected by the glyph construction tool 12, an image represented by the graphic materials is displayed in the display 111 of the glyph input interface 11. The graphic materials may be input by the user using any of the above and other input tools, or any combination thereof. If the user chooses to input in hand-writing, the user may input the graphic materials by the operation of a finger or a touch pen on the touch screen of the graphic input device 13 and transmit the graphic materials to the glyph construction tool 12. The user may also use a computer mouse (not shown) to input the graphic materials. In addition, the graphic input device 13, 13 may also connect an image scanner or a digital camera (both not shown), to input graphic materials of a glyph that is displayed in a graphic medium into the graphic input device 13, 13, followed by transmitting the graphic material to the glyph construction tool 12. All these methods are known in the technical field and commercially available devices or software may serve to provide these functions. Details thereof are thus omitted.

According to this invention, it is also possible to construct a glyph by modifying graphic materials downloaded from a computer device, a memory device or a website. It is also possible to download a batch of graph materials, in order to construct a plurality of glyphs. The graphic materials to be downloaded may be a group of glyph patterns, graphic designs or even vectorized glyphs. The glyph construction tool 12 provides glyph adjustment functions, including: When graphic materials of a glyph are input to the glyph construction module 10, the user is allowed to necessarily pre-process and adjust the graphic materials in the glyph input interface 11. For example, the user may click the “Adjust” key 114 for execution of tilt adjustments, thickness adjustments, translation of position, scaling of size etc. The user may also click the “BitThreshold” key 115 to adjust threshold values for conversion of colored images or gray-leveled images to black-and-white images, or to adjust threshold values for thinning process of the strokes, for vector extraction in a later step.

When the user determines the graphic materials, after pre-process, are ready for vector extraction, the user may click the “Extract” key 116 to actuate the glyph construction tool 12 to convert the graphic materials into a vectorized glyph. The glyph construction tool 12 is provided with a glyph pattern vectorization tool, which extracts feature vectors of stokes of the glyph and organizes them to form a vectorized pattern. The vector extraction technology is a mature technology in the technical field of image process. Extracting feature vectors of a pattern generally includes the steps of edge detection, thinning of edges, smoothing of edges and feature extraction, followed by vector extraction and organization of vectors so extracted. Many kinds of commercially available image process software are useful in the vector extraction process of this invention. They include: “Adobe Live Trace” by Adobe, “Vector Magic” by James Diebel and Jacob Norda, “Magic Tracer” by Elgorithms etc. By embedding one of these or other commercially available tools in the glyph construction tool 12, vectorization of the graphic materials would be easily realized. Of course, it is also possible to design a special tool to vectorized the graphic materials. In one embodiment of this invention, the graphic materials input by the user are vectorized into an “SVG” file by using the open source program of “Potrace.” In addition, many kinds of commercially available software are useful in the above-mentioned pre-process and adjustments. Details thereof are thus omitted.

Results of the vector extraction may be used to generate patterns of glyph, by the operations of the glyph construction tool 12. A pattern so generated is displayed in the glyph input interface 11, for the user's further modifications and confirmation. Here, the user may modify by changing the pattern and confirm completion of construction when results of the modification are satisfactory. When the user completes the construction of a glyph, the glyph data are saved by the glyph construction tool 12, in accordance with the user's instruction, for example, by clicking the “Save” key 117. When saving a glyph file, a code corresponding to the glyph is also designated and saved. To simplify management of the glyphs, code designated to a glyph is preferably identical to code designated to a symbol corresponding to the glyph in a generally accepted font system. For example, if the glyph represents a character (symbol) in the Chinese language, the code may be the glyph code of the symbol in a generally accepted Chinese font system, such as the Unicode system, or corresponding descriptions to the glyph code. In addition, if the glyph as constructed is the first glyph in a font file, upon construction the glyph construction tool 12 will request the user to designate a file name, so that the font file may distinguish itself from other font files. In the preferred embodiments of this invention, the file name may include personalized information such as name of the creator, representative codes of the input device etc. These code designation and name designation processes may be executed by the glyph construction tool 12 with instructions input by the user in the glyph input interface 11.

If the user does not need to confirm the glyphs one by one, the batch input function of the glyph construction tool 12 may be utilized. Briefly speaking, the glyph construction tool 12 provides vector extraction of a batch of graphic materials input or downloaded by a user at one time. After vectorization, the glyphs are given a respective glyph code according to their glyph codes and file name. It is also possible to request the user to input the respective glyph codes one by one for convenience of management. The font file so constructed is saved in the memory device 14 for further use. A font file so saved includes descriptions to a plurality of glyph patterns and glyph codes of the glyphs.

In some embodiments, the glyphs are not described by their feature vectors but by their graphic data, such as their bitmaps. Such approach saves the complicated calculation in the extraction of vectors, while memory capacity for storing the glyphs would increase. Other disadvantages of such approach include: difficulty in modification, scaling, tilting and other utilizations of the glyphs.

In the coding of the glyphs, in one example of the invention the user is familiar with computer font construction technologies and has sufficient knowledge in the generally accepted font systems. Such user may use hand-writing input tools of this invention to input glyphs and designate glyph codes directly. In another embodiment, the user is not aware of the computer font coding system, therefore uses recognition tools such as optical character recognition (OCR) tools or hand writing recognition (HWR) tools to input graphic materials of glyphs and to have them recognized automatically and displayed in the glyph input interface 11 for user's confirmation. After confirmation following necessary modifications, the glyphs are given their corresponding glyph codes in a generally accepted font system, such as the Unicode system, by using a known “character to code converter.” Coding of the glyphs is thus completed.

After the user has input and constructed a certain number of glyphs, the graphic pattern description and glyph codes of the glyphs, as well as other management information, are stored in the cloud-based font service system 100 as the user's own cloud-based computer font.

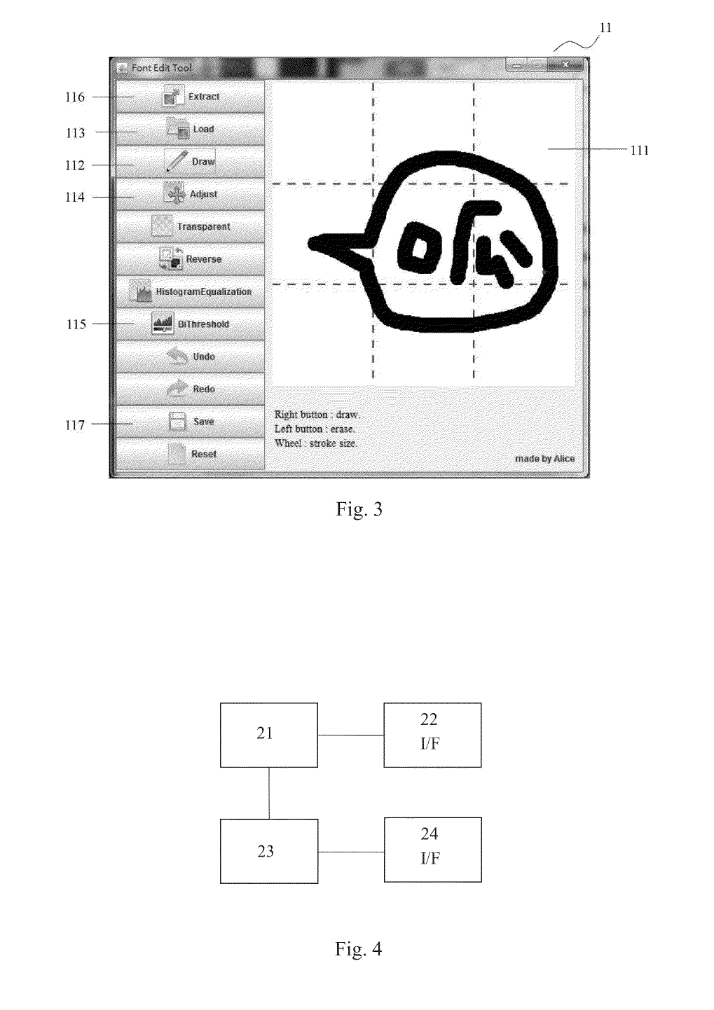

FIG. 4 is systematic diagram of the font management module 20 of this invention. As shown in this figure, the font management module 20 allows a user to edit font files online, after the user connects a computer device with the cloud-based font service system 100, and to put the font file shelving. According to this invention, the font management module 20 includes a font file edition module 21, a glyph edition interface 22, a font shelving module 23 and a font shelving interface 24. Users are allowed to edit their own font files, including adding new glyphs, modifying existing glyphs, deleting existing glyphs etc., online in a webpage or offline using a computer program, through an interface, such as the glyph edition interface 22. In addition, users are allowed to transmit a font file to the font application module 30 through, for example, the font shelving interface 24, in order to trade, share or exchange the font with another user.

The font file edition module 21 is provided in the cloud-based font service system 100, to utilize the strong operation and storage capacity of the system, so to facilitate numerous users to online edit their own font files, such as addition, modification and deletion of glyphs of the font files. Among them, adding new glyphs may be realized in a manner similar to construction of glyphs. Users simply construct new glyphs, designate glyph codes and include the new glyph in an existing font file, following steps as shown in FIG. 2. Deletion of glyphs is realized by simply deleting particular glyphs from a font file, which is a known technology in the field. One feature of this invention is that the font file edition functions of the font file edition module 21 allow a user to select desired glyphs from font files constructed by the same user or by other users, as they are provided in the cloud-based font service system 100, to construct a new font file and to put the newly constructed font file on shelve. According to this invention, the font file edition module 21 also allows users to modify a font file by adding, replacing, modifying or delete glyphs.

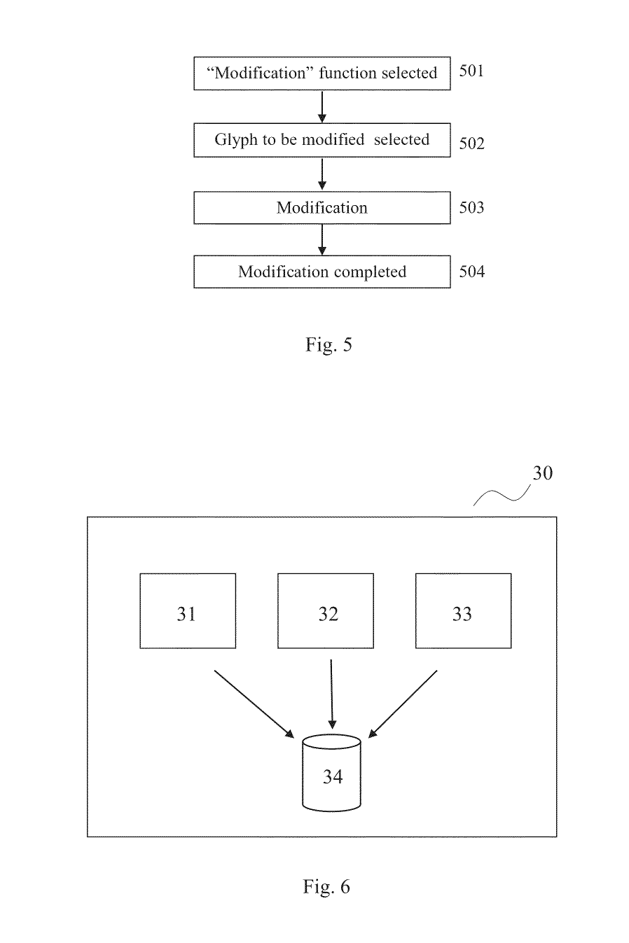

In the followings, a method for process of modification of a glyph, according to one example of this invention, will be described by referring to this figure. FIG. 5 is the flowchart of a method for modification of a glyph, according to one example of this invention. As shown in FIG. 5, at 501 a user selects “modification” function in the glyph edition interface 22. At 502 the user selects from a font file a glyph to be modified. At 503 the user modifies the glyph by changing its pattern or code in the glyph edition interface 22, to obtain a new glyph. At 504, the user clicks the “confirmed” key to complete the modification. Following that, the font file edition module 21 replaces the old glyph with the new glyph and saves the modified file in the storage device 14.

In the font file edition module 21 of this invention, a plurality of glyph modification tools is provided. Tools provided may include: a glyph pattern replacement tool, a glyph pattern modification tool and a glyph code modification tool. Among them, the glyph pattern replacement tool allows users to access the glyph input interface 11, input graphic materials for a glyph, modify the graphic materials to form a glyph and replace an existing glyph with the newly constructed glyph. The glyph pattern modification tool allows users to select from a particular font file a glyph to be modified, display the selected glyph pattern on the glyph input interface 11, modify the glyph pattern using tools provided in the glyph input interface 11 and save the modified glyph pattern into the selected glyph file. The glyph pattern modification tool may also allow users to save the modified glyph pattern into the same font file, with a new glyph code or to save the modified glyph pattern into another font file. With this function, users are allowed to use existing glyphs to construct new glyphs or even new font files. The glyph code modification tool allows users to select a glyph from a particular font file, change its glyph code and save the glyph into the same font file or another font file. All these tools may be realized by using existing technologies or commercially available or open source software. Details thereof are thus omitted.

In this particular example, a glyph construction tool 12 and a font file edition module 21 are provided separately. It is however appreciated that the glyph construction tool 12 focuses on edition functions for particular glyphs, while the font file edition module 21 focuses on edition functions for font files. Since they both provide modification and edition functions for glyphs, some of their functions are exchangeable or supplemental.

The font shelving module 23 allows users to transmit font files they constructed to the font application module 30 through the font shelving interface 24, so that users may trade, share or exchange their font files with other users. When a font file constructed by one user has include a substantial number of glyphs, or when the font file includes glyphs of highly artistic values or commercial values, owner of the font file may connect a computer device with the font shelving module 23, select the font shelving interface 24, verify and select particular font files or particular glyphs of a font file in the font file edition interface 22, input commercial conditions such as price of use, determine format for display of font file and instruct the font shelving module 23 to transmit the selected font file or glyphs to the font application module 30. The font file or glyphs so transmitted will be displayed in accordance with the user's instructions and provided to other users for utilization upon their requests.

FIG. 6 is systematic diagram of one embodiment of the font application module 30 of the cloud-based font service system 100 of this invention. As shown in this figure, the font application module 30 of this invention includes a font trading and processing module 31, a font trading interface 32 and a settlement module 33. The font trading and processing module 31 accepts font files provided by their owner, stores the font file in the storage device 34 of the font application module 30 and designates a font code to the font file. In the embodiments of this invention, the cloud-based font service system 100 serves to process a large quantity of font files. As a result, classification and management of font files are critical for the application of this invention. The font trading and processing module 31 is provided with one or more than one predetermined classification system, to allocate all font files into their corresponding classes. In addition, it is possible to attach tags that describe the attributes of a font to the font files, to enhance efficiencies in classification and management. The font trading interface 32 provides a graphic interface that selectively displays introduction or description of fonts available for trading, provides input columns for consumers to input their requests and displays particular contents of glyphs or fonts in response to consumers' requests. The respective font files are stored in the storage device 34 and, upon consumers' request generated in the font trading interface 32, descriptive or introductive information of a particular font file may be displayed in the font trading interface 32 to encourage the consumers' further actions.

When a consumer purchases a particular font file by clicking a predetermined key, commercial conditions and restrictions in the utilization of the selected font file are displayed in the font trading interface 32 by the font trading and processing module 31. After the consumer's acceptance of the conditions is received, the settlement module 33 takes over the process and uses settlement tools known in the field of internet commerce to close the deal. The purchased font file or glyphs are then provided to the computer device of the consumer.

In particular embodiments of this invention, the font file edition module 21 further operates to include a number of glyphs from one or more font files according to instructions of a user, to form a font file. Such design is particularly suited in the utilization of fonts of higher artistic values or commercial values. In addition, such an application simplifies display and printing out of documents that include special type faces. As described above, in the conventional art it is very difficult to display or print out documents that include special type faces, if the receiver computer is not embedded with computer fonts of the special type faces. If the font file that includes the special type faces is transmitted along with the documents, unnecessarily larger capacity of the transmission channel would be needed. By using the cloud-based font service system of this invention, it will be possible to design an application program to exact glyph codes from the document and automatically select desired glyphs from particular font files, to form a new font file, so that the newly constructed font file may be transmitted along with the document.

Capacity of transmission channels needed in the transmission of the document is thus reduced, while the document may be correctly displayed and printed out. Of course, expenses for partial utilization of the font files may be calculated and collected by the font application module 30. In addition, the glyphs to be included in such a font file are not limited to those existing in the document.

### EFFECTS OF THE INVENTION

The cloud-based font service system of this invention provides users facilities in constructing their own font files. Users without special knowledge in computer or internet or glyph design capabilities are allowed to construct their own glyphs in the font file edition interface 22 glyph by glyph or in batch. When a number of glyphs is constructed, a font file with commercial values may be obtained, saved in the cloud server and provided for consumers' purchase, download, display or utilization. In addition, a font file so constructed may be embedded into an internet domain or a webpage. Visitors of the internet domain or webpage do not need to install special font files, in order to correctly display contents of the internet domain or webpage.

The font file may also be embedded in a document, so that a receiver of the document does not need to install a full font file, in order to correctly display or print out the document. The settlement module of this invention automatically calculates and collects expenses for the utilization of the font file.

What is claimed is:

1. A cloud-based font service system installed in a cloud server, comprising
a glyph construction module comprising a glyph construction tool and a glyph input interface, to allow users to input graphic materials to construct glyph patterns corresponding to a plurality of symbols, letters or characters and to convert said graphic materials to digital glyphs in a particular format for construction of a computer font;
a font management module comprising a font edition tool that allows users to add, modify or delete glyph patterns of said computer font and a font shelving interface that allows an administrator of said computer font to determine access rights and method of display of the computer font; and
a font application module comprising a computer font trading interface to display particular glyphs of the computer font in a particular format, for consumers' selection, download or use of the computer fonts;
wherein the font edition module allows users to select glyphs from a plurality of computer fonts in the cloud-based font service system to form a new computer font for displaying in the computer font trading interface.

2. The cloud-based font service system of claim 1, wherein a computer font is represented by digital information describing glyph patterns and glyph codes of a particular number of glyphs included in the computer font and trading conditions of the computer font.

3. The cloud-based font service system of claim 2, wherein digital information describing glyph patterns includes vectorized description of the glyph pattern.

4. The cloud-based font service system of claim 2, wherein digital information describing glyph patterns includes dot-matrix description of the glyph pattern.

5. The cloud-based font service system of claim 1, wherein the glyph construction module further includes a computer font storage device to store information representing glyph patterns of a plurality of computer fonts and trading conditions of respective computer fonts and to provide the information for public access through the cloud server.

6. The cloud-based font service system of claim 1, wherein the glyph input interface is configured to accept graphic materials input through at least a tool selected from the group consisted of a hand-writing input tool, an image input tool and a digital glyph downloading tool.

7. The cloud-based font service system of claim 1, wherein the glyph construction module converts said graphic materials to digital glyphs by exacting features vectors of elements of the graphic materials.

8. The cloud-based font service system of claim 1, wherein the glyph construction module automatically recognizes a symbol, letter or character represented by the graphic materials, displays results of recognition and generates a glyph code upon confirmation by a user of the results being displayed.

9. The cloud-based font service system of claim 8, wherein the glyph code includes representative code of the symbol, letter or character in a generally accepted computer font system.

10. The cloud-based font service system of claim 1, wherein the font application module further comprises a settlement module, to close a deal in accordance with trading conditions corresponding to a computer font selected by a customer.

11. The cloud-based font service system of claim 1, wherein the font management module automatically exacts glyph codes from a document, selects desired glyphs from related computer fonts to form a new font file, and attaches the new font file to a document to be transmitted.
